(19) United States
(12) Patent Application Publication
(10) Pub. No.: US 2018/0275876 A1
(43) Pub. Date: Sep. 27, 2018

(54) DISK DEVICE AND DISK DEVICE CONTROL METHOD

(71) Applicant: Kabushiki Kaisha Toshiba, Minato-ku (JP)

(72) Inventors: Kenshu NAKASHIMA, Yokohama (JP); Seiji Toda, Kawasaki (JP); Michihiko Umeda, Yokohama (JP); Yasuyuki Nagashima, Yokohama (JP)

(73) Assignee: Kabushiki Kaisha Toshiba, Minato-ku (JP)

(21) Appl. No.: 15/695,614

(22) Filed: Sep. 5, 2017

(30) Foreign Application Priority Data
Mar. 22, 2017 (JP) 2017-055529

(51) Int. Cl. G06F 3/06

(52) U.S. Cl. CPC G06F 3/061; G06F 12/0868; G06F 3/0674; G06F 3/0659

(57) ABSTRACT

According to one embodiment, there is provided a disk device including a disk medium, a command queue, and a controller. The disk medium stores data in accordance with addresses. Into the command queue, commands are enqueued in order. The controller regroups a plurality of groups grouped correspondingly to the addresses in the disk medium in response to a command enqueued into the command queue or a command dequeued from the command queue, and performs a process for the command queue based on the regrouped plurality of groups.

### CROSS-REFERENCE TO RELATED APPLICATIONS

This application is based upon and claims the benefit of priority from Japanese Patent Application No. 2017-055529, filed on Mar. 22, 2017; the entire contents of which are incorporated herein by reference.

### FIELD

Embodiments described herein relate generally to a disk device and a disk device control method.

### BACKGROUND

In disk devices, commands are sequentially enqueued into a command queue, and, thereafter, commands dequeued from the command queue are executed. In disk devices, when commands are executed, there is a mechanical waiting time, such as a seek time, a rotation waiting time, etc. The mechanical waiting time varies depending on the physical address inside a disk medium. In order to improve the access performance of a disk device, it is desired to suitably perform a process for a command queue, such as to suitably reorder commands stored in the command queue.

### BRIEF DESCRIPTION OF THE DRAWINGS

FIG. 1 is a diagram illustrating a configuration of a disk device according to an embodiment;

FIG. 2 is a flowchart illustrating operations in command enqueueing in the embodiment;

FIGS. 3A and 3B are diagrams illustrating operations in the command enqueueing in the embodiment;

FIGS. 4A and 4B are diagrams illustrating operations in the command enqueueing in the embodiment;

FIG. 5 is a flowchart illustrating operations in command dequeueing in the embodiment;

FIGS. 6A and 6B are diagrams illustrating operations in the command dequeueing in the embodiment;

FIGS. 7A and 7B are diagrams illustrating operations in the command dequeueing in the embodiment;

FIG. 8 is a flowchart illustrating operations in command enqueueing in a modification of the embodiment;

FIGS. 9A and 9B are diagrams illustrating operations in the command enqueueing in the modification of the embodiment;

FIGS. 10A and 10B are diagrams illustrating operations in the command enqueueing in the modification of the embodiment;

FIG. 11 is a flowchart illustrating operations in command dequeueing in another modification of the embodiment;

FIGS. 12A and 12B are diagrams illustrating operations in the command dequeueing in the other modification of the embodiment; and

FIGS. 13A and 13B are diagrams illustrating operations in the command dequeueing in the other modification of the embodiment.

### DETAILED DESCRIPTION

In general, according to one embodiment, there is provided a disk device including a disk medium, a command queue, and a controller. The disk medium stores data in accordance with addresses. Into the command queue, commands are enqueued in order. The controller regroups a plurality of groups grouped correspondingly to the addresses in the disk medium in response to a command enqueued into the command queue or a command dequeued from the command queue, and performs a process for the command queue based on the regrouped plurality of groups.

Exemplary embodiments of a disk device will be explained below in detail with reference to the accompanying drawings. The present invention is not limited to the following embodiments.

### Embodiment

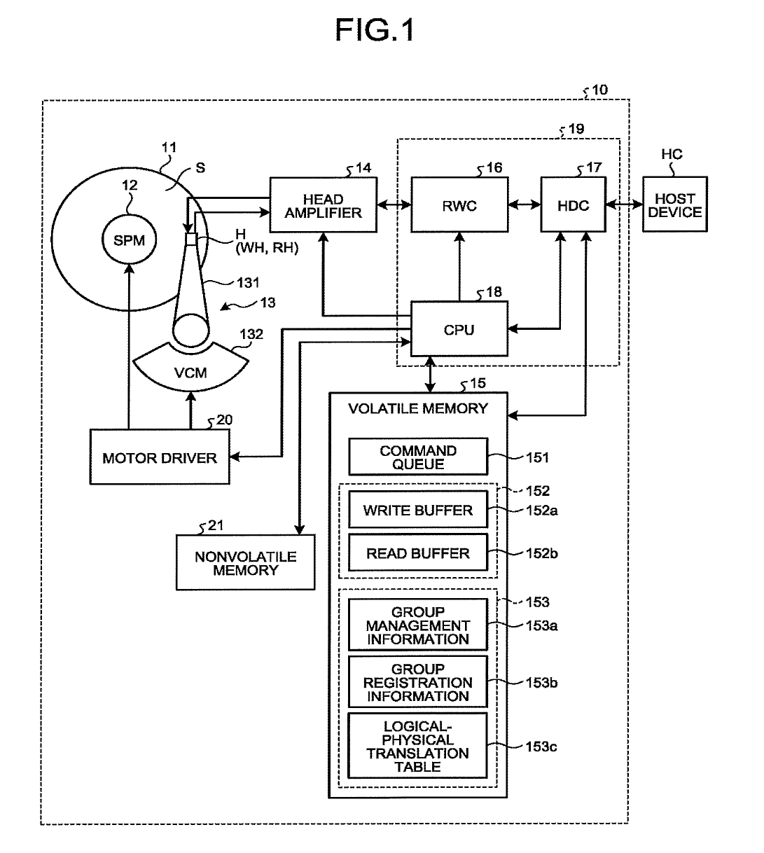

An explanation will be given of a disk device 10 according to an embodiment, with reference to FIG. 1. FIG. 1 is a diagram illustrating a configuration of the disk device 10.

The disk device 10 includes a disk medium 11, a spindle motor 12, an HSA (Head Stack Assembly) 13, a head amplifier 14, a volatile memory 15, an RWC (Read/Write Channel) 16, an HDC (Hard Disk Controller) 17, a CPU (Central Processing Unit) 18, a motor driver 20, and a nonvolatile memory 21.

The disk medium 11 includes a recording surface S for recording data on each of the front and rear surfaces. The disk medium 11 is driven for rotation by the spindle motor 12. The disk device 10 is provided with a plurality of disk media 11. Further, every recording surface S used in the disk device 10 is provided with physical addresses set as positional information indicating physical positions on the recording surface S. The spindle motor 12 is driven by electric current (or voltage) supplied from the motor driver 20.

The HSA 13 includes a head H, a head suspension 131, and a VCM (Voice Coil Motor) 132. The head H is provided for every recording surface S of the disk medium 11. The head H includes a write head WH and a read head RH. The write head WH is used for writing data into disk medium 11. The read head RH is used for reading data from the disk medium 11.

The head suspension 131 is provided for every head H, and supports the head H. The VCM 132 is driven by electric current (or voltage) supplied from the motor driver 20. The head suspension 131 and the VCM 132 constitute an actuator. The actuator performs control by using drive of the VCM 132 to move the head H supported by the head suspension 131 to a predetermined position on the recording surface S of the disk medium 11. With this arrangement of the HSA 13, the head H can move in a radial direction of the recording surface S of the disk medium 11.

The motor driver 20 supplies electric current or voltage to the spindle motor 12, and thereby drives the spindle motor 12 at a predetermined rotational speed. Further, the motor driver 20 supplies electric current or voltage specified by the CPU 18 to the VCM 132, and thereby drives the actuator.

The head amplifier 14 causes a write signal (electric current), which corresponds to write data input from the RWC 16, to flow to the head H. Further, the head amplifier 14 amplifies a read signal output from the head H (read data read from the disk medium 11 by the head H), and supplies the read signal to the RWC 16.

The RWC 16 is a signal processing circuit. The RWC 16 performs encoding (code modulation) to write data input from the HDC 17, and outputs the write data to the head amplifier 14. Further, the RWC 16 performs decoding (code demodulation) to read signal transmitted from the head amplifier 14 into read data, and outputs the read data to the HDC 17.

The HDC 17 performs control for transmitting and receiving data to and from a host device HC via an I/F bus, and performs other control. The HDC 17 includes a host interface (host I/F) circuit (not shown).

The CPU 18 performs overall control of the disk device 10, in accordance with firmware stored in the nonvolatile memory 21 or disk medium 11. For example, the CPU 18 executes various control processes, such as a control process for read or write by each head H, and a servo control process for controlling the position of each head on the corresponding recording surface S of the disk medium 11. The firmware includes initial firmware, which is executed first at startup of the disk device 10, and control firmware, which is used in the normal operation of the disk device 10.

It should be noted that a hardware configuration including the RWC 16, the HDC 17, and the CPU 18 can be regarded as a controller 19. The controller 19 may be configured as an integrated circuit formed of one chip (system-on-chip). The package of the controller 19 may be disposed on a printed board outside a casing (not shown) that accommodates the disk medium 11, the spindle motor 12, and the HSA 13.

The nonvolatile memory 18 is connected to the CPU 18 of the controller 19, and is configured to be rewritten by the CPU 18.

The volatile memory 15 is formed of a volatile memory, such as a DRAM (Dynamic RAM) or SRAM (Static RAM). The volatile memory 15 includes a command queue 151, a buffer 152, and a working area 153. The working area 153 is used to temporarily store data and so forth by the controller 19. For example, the CPU 18 reads group management information 153a, group registration information 153b, and a logical-physical translation table 153c, which are stored in a management information area of the disk medium 11, via the head H, the head amplifier 14, the RWC 16, and the HDC 17, and stores them into the working area 153.

The command queue 151 sets a plurality of commands received by the HDC 17, to be queued in order of their reception. Each of the plurality of commands includes a logical address for accessing the disk medium 11. The command queue 151 serves as a queue buffer, and the respective commands are dequeued in order of their enqueue. Specifically, the command queue 151 has an FIFO structure. However, the command queue 151 may be dequeued in order different from their enqueue, if a reordering process described later is performed and stored commands are reordered.

The buffer 152 includes a write buffer 152a and a read buffer 152b. The write buffer 152a temporarily stores data that is to be written into the disk medium 11 by a command (such as a write command) instructing writing of write data into the disk medium 11. The read buffer 152b temporarily stores data that has been read from the disk medium 11 by a command (such as a read command) instructing reading of read data from the disk medium 11.

The write command includes the head LBA (Logical Block Address) of a logical sector corresponding to the writing destination of write data, among the logical sectors managed by the disk device 10, and the write data length. On the other hand, the read command includes the head LBA of a logical sector that stores read data to be read, among the logical sectors managed by the disk device 10, and the read data length. The LBA may be also referred to as “logical address”.

The logical-physical translation table 153c in the working area 153 is information that correlates logical addresses with physical addresses, and can be fixedly used without being rewritten under normal conditions. Accordingly, in the disk device 10, if the logical addresses of a plurality of commands are consecutive, physical addresses to be accessed by the plurality of commands can be presumed to be also consecutive. Here, the physical address includes a combination of a cylinder number and a sector number, for example. The cylinder number is a number for identifying a cylinder. The cylinder is a unit of a storage area extending over a plurality of tracks corresponding to each other in a vertical direction in a plurality of disk media 11. The sector number is a number for identifying a sector position in one track. Specifically, in relation to part of the information of the physical address, physical addresses are consecutively allocated in respective tracks, for every one of a plurality of tracks adjacent to each other in the disk medium 11. Here, the physical address includes a head number (recording surface number), and physical addresses may be consecutively allocated to a plurality of tracks adjacent to each other in a vertical direction in the cylinder.

In the command queue 151, the commands are queued in order of their reception from the host device HC. However, when a random access process is performed by a command, if commands are executed in order of reception, a mechanical waiting time including a seek time and a rotation waiting time is likely increased. Accordingly, the controller 19 (CPU 18) performs a reordering process for reordering the commands in the command queue 151 into a state where the commands are queued in order of from a command having a closer physical address corresponding to the head LBA. Consequently, it can be expected to reduce the mechanical waiting time that accompanies an access operation to the disk medium 11 in accordance with command execution.

In the reordering process, the controller 19 (CPU 18) selects each of the commands queued in the command queue 151, and obtains a mechanical waiting time to be generated in a case where a selected command is executed following a command currently executed. By doing so, the controller 19 (CPU 18) performs evaluation to determine a command that makes the mechanical waiting time minimum. As the number of commands to be evaluated is larger, the evaluation time is prolonged and the reordering process time is easily increased.

In order to shorten the reordering process time, it is necessary to provide a scheme for limiting the number of commands to be evaluated. For example, in order to limit the number of commands to be evaluated, if all the commands queued in the command queue 151 are subjected to a judgment as to whether the head LBA falls within a range regarded as being close to the tail LBA of a command currently executed, this judgment requires a certain time and likely increases the reordering process time.

On the other hand, if the logical addresses corresponding to the physical addresses in the disk medium 11 are sectioned into a plurality of groups for respective ones of consecutive address ranges, and a judgment is made as to which group a command currently executed belongs to, the number of commands to be evaluated can be limited by a simple judgment. Consequently, it can be expected to shorten the judgment time and thereby to shorten the reordering process time.

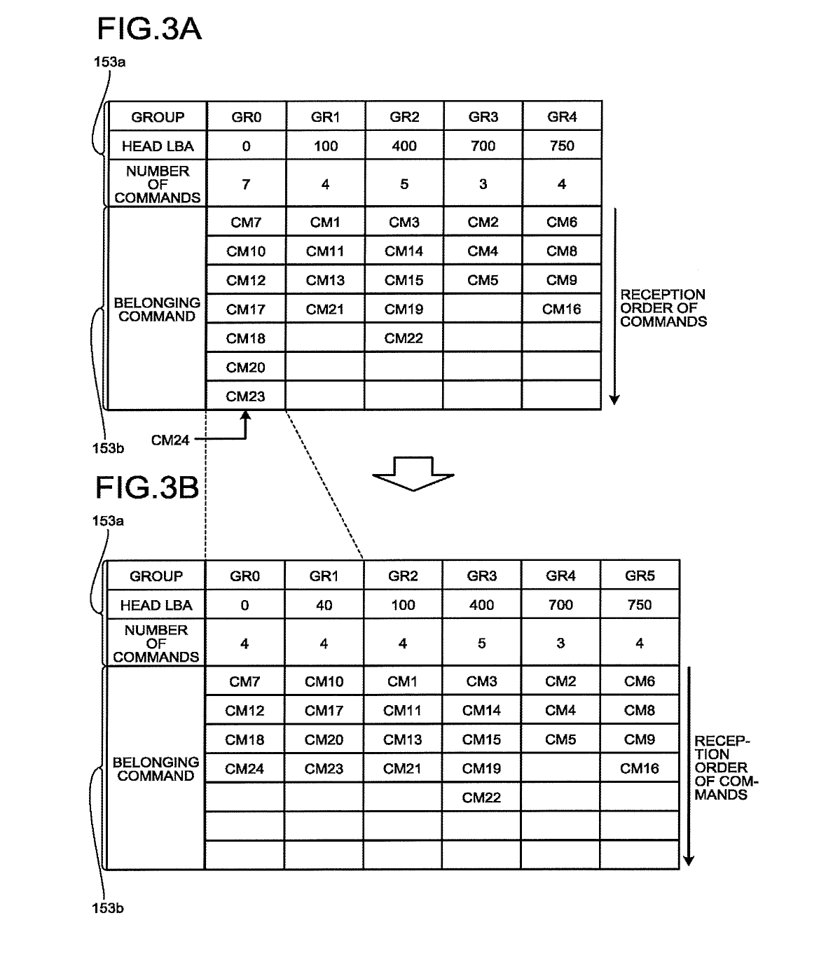

Accordingly, the controller 19 (CPU 18) stores the group management information 153a and the group registration information 153b in the working area 153. The group management information 153a is information for managing groups allocated by the controller 19 (CPU 18) to the commands queued in command queue 151. The group management information 153a includes information that correlates information for identifying a group, with the head LBA of the group and the number of commands in the group, for respective one of a plurality of groups (see FIGS. 3A and 3B). In the group management information 153a, each group corresponds to a range of consecutive logical addresses. As consecutive logical addresses almost correspond to consecutive physical addresses, it can be assumed that the physical positions of storage areas in the disk medium 11 are almost consecutive, in one group.

In accordance with a judgment as to which one of the logical address ranges (groups) of the group management information 153a the head LBA of each command belongs to, the controller 19 (CPU 18) allocates a group to each command, and registers it into the group registration information 153b. The group registration information 153b is information to be renewed in response to a change (enqueue or dequeue) of the commands queued in command queue 151, and is rewritten by the controller 19 (CPU 18). The group registration information 153b is registration information that correlates information for identifying a command, with a group allocated in accordance with the logical address of the command, for respective one of the commands queued in command queue 151 (see FIGS. 3A and 3B). Each group is treated as a unit for performing the reordering process.

When a command is dequeued from the command queue 151 and starts being executed, the controller 19 (CPU 18) specifies a group to which the command currently executed belongs, and performs a reordering process to evaluate the respective commands registered in the group.

As the capacity of the volatile memory 15 is larger, and the depth of the command queue 151 is greater (the number is increased), the number of commands allocated to each group tends to be increased. For example, if command access is concentrated onto a specific address range, the number of commands allocated to the corresponding group ends up being increased. In this case, if the evaluation is performed to all the commands in the group corresponding to the command currently executed, the reordering process time, which should not be larger than the process time of the command currently executed, is easily prolonged to an extent that exceeds the command process time. Consequently, an overhead of firmware likely comes up, e.g., such that the next command execution start needs to wait until the reordering process is completed.

On the other hand, a method can be considered to perform the evaluation not to all the commands in each group, but to some of the commands in the group, for example, by limiting the number of commands in ascending order of queuing. In this method, however, if a command having an LEA close to the tail LBA of the command currently executed is included in commands that were not evaluated, the precision of the reordering process is easily lowered.

In consideration of the above, according to this embodiment, in the disk device 10, regrouping is dynamically performed so that the number of commands can fall within a predetermined range, to achieve both of suppression of increase of the reordering process time and suppression of deterioration of the reordering process precision.

Specifically, in a case where commands are concentrated onto a specific address range, the commands that belong to the specific group are likely increased. In this case, the number of commands to be subjected to the reordering evaluation in a group becomes smaller, and a more effective command cannot be selected, as the case may be. Accordingly, division of groups is performed such that the number of commands that belong to each group does not become a certain value or more, and integration of groups is performed to prevent an increase of the number of groups.

Specifically, the controller 19 regroups a plurality of groups in the group management information 153a, in response to that a command is enqueued into the command queue 151 or a command is dequeued from the command queue 151. Further, the controller 19 renews the group registration information 153b in response to that the group management information 153a is renewed.

When finding that a command is enqueued into the command queue 151, the controller 19 allocates a group in the group management information 153a to this command. Further, the controller 19 registers this command into the group registration information 153b, and obtains the number of commands in the allocated group. The controller 19 compares the number of commands thus obtained with a threshold TH1, and judges whether the number of commands exceeds the threshold TH1. When the number of commands exceeds the threshold TH1, the controller 19 divides and regroups this group, and renews the group management information 153a. In accordance with this renewal, the controller 19 reconstitutes and renews the group registration information 153b. Consequently, it is possible to set the number of commands in each group in the group management information 153a to fall within a certain range (that is a range of the number of commands, which allows the reordering process time to be equal to or less than the command process time, even if the evaluation is performed to all the commands in the group). As a result, the controller 19 can precisely perform the reordering process, while preventing an increase of the reordering process time, and can suitably reorder the commands in the command queue 151 in accordance with the process result.

Further, when finding that a command is dequeued from the command queue 151, the controller 19 deletes this command from the group registration information 153b. Then, the controller 19 obtains the number of commands in the group to which this command was allocated, and the number of commands in a group adjacent to this group. The controller 19 compares the sum of the number of commands in the group to which this command was allocated and the number of commands in the group adjacent to this group, with a threshold TH2, and judges whether the sum is smaller than the threshold TH2. When the sum is smaller than the threshold TH2, the controller 19 integrates this group with the adjacent group, and renews the group management information 153a. In accordance with this renewal, the controller 19 reconstitutes and renews the group registration information 153b. Consequently, it is possible to reduce the number of groups, while keeping the number of commands in each group in the group management information 153a to fall within a certain range (that is a range of the number of commands, which allows the reordering process time to be equal to or less than the command process time, even if the evaluation is performed to all the commands in the group). As a result, the controller 19 can reduce the time necessary for group management, and can prevent an increase of the reordering process time.

It should be noted that, if “the threshold TH2<the threshold TH1” is satisfied, it becomes possible to prevent the division and integration from being frequently repeated, and to stabilize a control process of the controller 19 in relation to the division and integration.

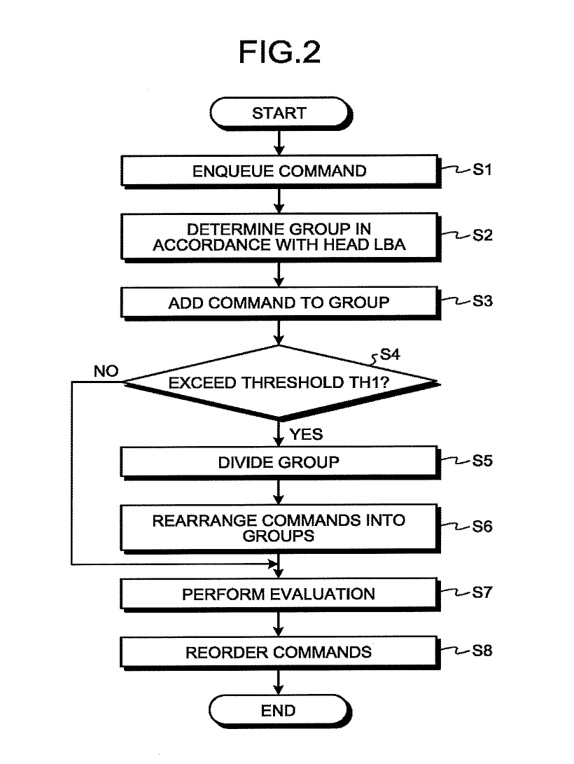

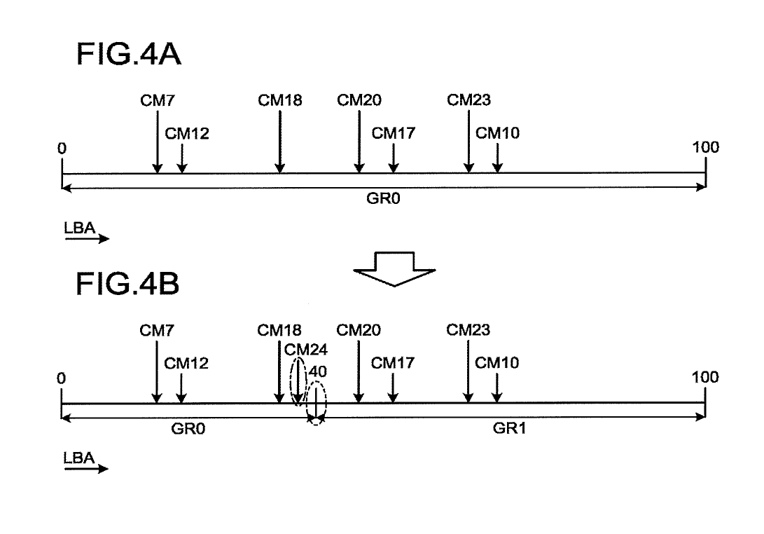

For example, in response to that a command is enqueued into the command queue 151, as illustrated in FIGS. 2 to 4B, the controller 19 performs regrouping by dividing one or more groups among a plurality of groups. FIG. 2 is a flowchart illustrating operations of the controller 19 in command enqueueing. FIGS. 3A, 3B, 4A, and 4B are diagrams illustrating operations of the controller 19 in the command enqueueing. In FIGS. 3A, 3B, 4A, and 4B, the reception order of commands from the host device HC is denoted by using CM+“number”.

When receiving a command from the host device HC, the controller 19 enqueues this command into the command queue 151 (S1). The controller 19 acquires the head LBA of the access destination of the received command. With reference to the group management information 153a, the controller 19 determines a group including the acquired head LBA, as a group into which the received command is to be registered (S2). With reference to the group registration information 153b, the controller 19 adds the received command to the group registration information 153b, as the last command in the determined group (S3).

On the basis of the group management information 153a and/or the group registration information 153b, the controller 19 obtains the number of commands in the group to which the received command has been added. For example, with reference to the group management information 153a, the controller 19 obtains the number of commands in the command-added group, by calculating “the current number of commands in the group”+1. Alternatively, the controller 19 obtains the number of commands in the group to which the received command has been added, by counting the number of commands in the received-command-added group, in the group registration information 153b.

The controller 19 compares the number of commands in the received-command-added group with the threshold TH1, and judges whether the number of commands in the received-command-added group exceeds the threshold TH1 (S4). When the number of commands in the received-command-added group does not exceed the threshold TH1 (No at S4), the process proceeds to S7.

When the number of commands in the command-added group exceeds the threshold TH1 (Yes at S4), the controller 19 renews the group management information 153a so as to divide the group (S5).

For example, an explanation will be given of a case where the threshold TH1=7, and a command CM24 is added to a group GR0 to which commands CM7, CM10, CM12, CM17, CM18, CM20, and CM23 belong, as illustrated in FIG. 3A. On the basis of the group management information 153a, the controller 19 obtains the current number of commands 7+1=8 in the group GR0. The controller 19 compares the number of commands “8” in the group GR0 with the threshold TH1 (=7), and judges that the number of commands in the group GR0 exceeds the threshold TH1. In accordance with this judgment result, the controller 19 renews the group management information 153a as illustrated in FIG. 3B, by dividing the current group GR0 into groups GR0 and GR1, and renumbering the other current groups GR1 to GR4 into groups GR2 to GR5. At this time, the controller 19 regroups the current group GR0 into groups GR0 and GR1 such that the number of commands in each of the groups GR0 and GR1 falls within a predetermined range.

FIG. 4A illustrates the head LBAs of the respective commands CM7, CM10, CM12, CM17, CM18, CM20, and CM23 that belong to the current group GR0. An explanation will be given of a case where, as illustrated in FIG. 4A, with respect to an address range of from the head LBA “0” of the current group GR0 to the head LBA “100” of the current group GR1, the command CM24 is added at an address position illustrated in FIG. 4B. In this state, the current group GR0 is divided into groups GR0 and GR1 such that the numbers of commands that belong to the respective groups GR0 and GR1 obtained by division are almost equal to each other.

Further, in a case where the number of commands is expected to become larger in the group GR0 than in the group GR1 thereafter, the controller 19 may divide the current group GR0 into the groups GR0 and GR1 such that the number of commands in the group GR0 is made smaller than the number of commands in the group GR1. Alternatively, in a case where the number of commands is expected to become smaller in the group GR0 than in the group GR1 thereafter, the controller 19 may divide the current group GR0 into the groups GR0 and GR1 such that the number of commands in the group GR0 is made larger than the number of commands in the group GR1.

In accordance with the renewed group management information 153a, the controller 19 rearranges commands into groups (S6). Specifically, the controller 19 reconstitutes the group registration information 153b, and renews the group registration information 153b.

For example, as illustrated in FIGS. 3B and 4B, the group registration information 153b is reconstituted and renewed such that the commands CM7, CM12, CM18, and CM24 belong to the group GR0, and the commands CM10, CM17, CM20, and CM23 belong to the group GR1.

The controller 19 specifies a group to which the head LBA of a command currently executed belongs. The controller 19 selects each of the commands that belong to the group, and obtains a mechanical waiting time to be generated in a case where a selected command is executed following the command currently executed. By doing so, the controller 19 performs evaluation to determine an execution order of the commands that makes the mechanical waiting time minimum (S7). The controller 19 reorders (performs reordering to) the commands stored in the command queue 151 such that the commands come into the determined execution order (S8).

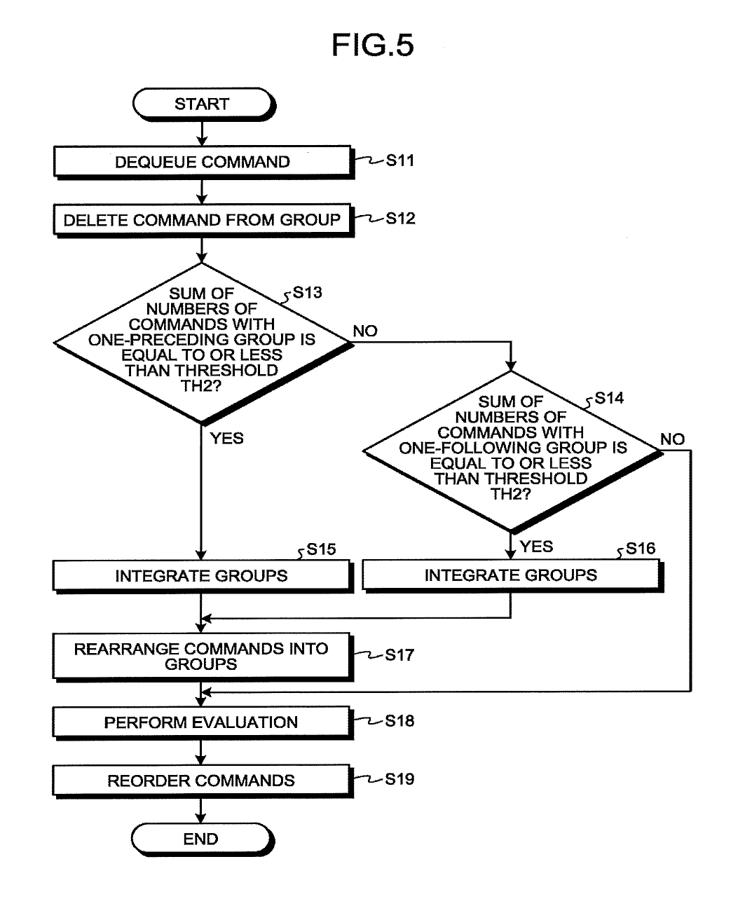

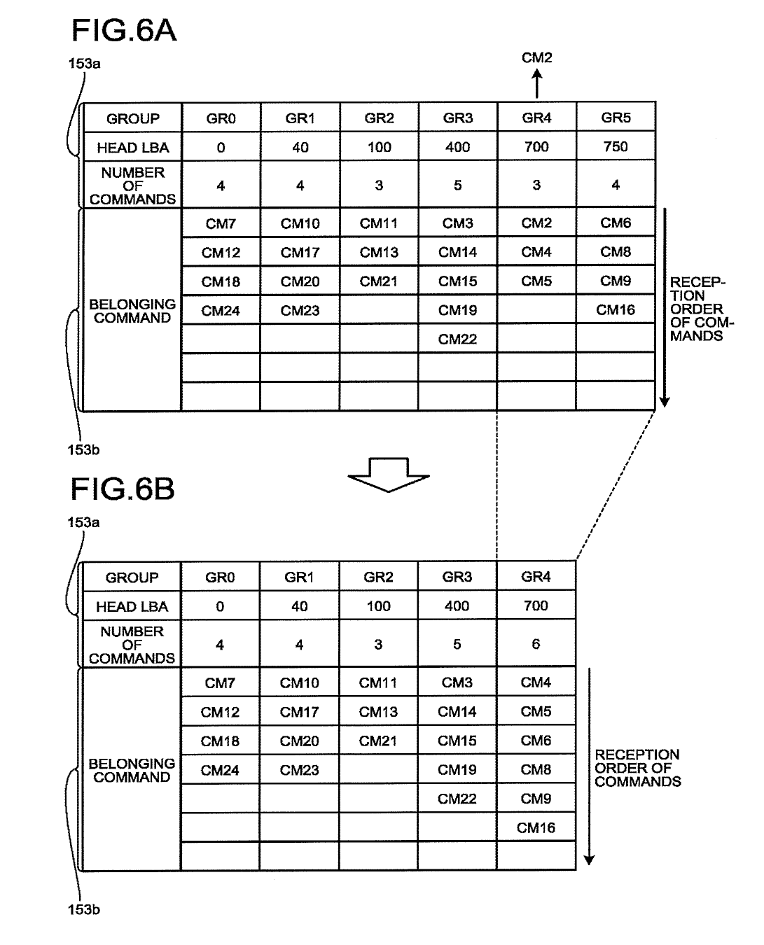

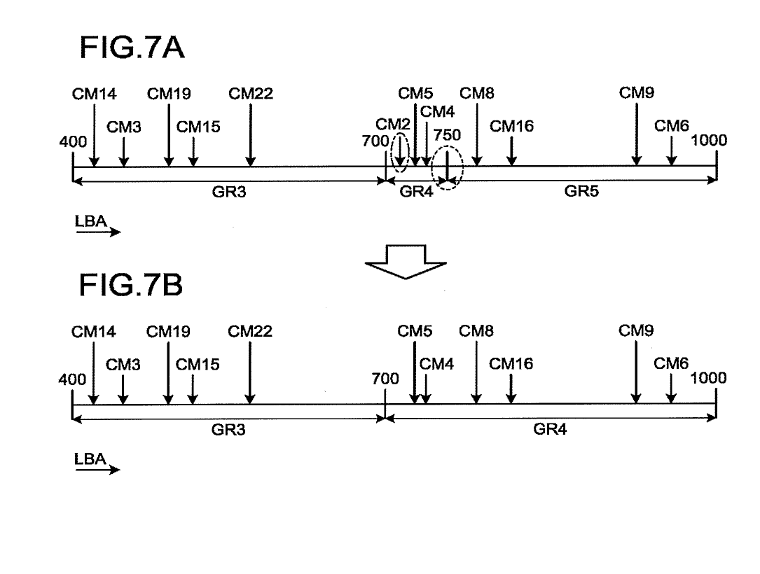

Further, for example, in response to that a command is dequeued from the command queue 151, as illustrated in FIGS. 5 to 7B, the controller 19 performs regrouping by integrating two or more groups among a plurality of groups. FIG. 5 is a flowchart illustrating operations of the controller 19 in command dequeueing. FIGS. 6A, 6B, 7A, and 7B are diagrams illustrating operations of the controller 19 in the command dequeueing. In FIGS. 6A, 6B, 7A, and 7B, the reception order of commands from the host device HC is denoted by using CM+“number”.

When execution of a command is completed, the controller 19 dequeues the command, which is at the head of the command queue 151 and has been completed in execution, from the command queue 151 (S11). With reference to the group management information 153a, the controller 19 deletes the dequeued command form the group to which the command has belonged in the group management information 153a (S12).

On the basis of the group management information 153a and/or the group registration information 153b, the controller 19 obtains the number of commands in the group from which the dequeued command has been deleted, and the number of commands in a group one-preceding the group (that is a group adjacent to the group in the group management information 153a and having a start LBA smaller than that of the group). With reference to the group management information 153a, the controller 19 obtains the number of commands in the dequeued-command-deleted group, by calculating “the current number of commands in the group”−1, and further obtains the number of commands in the one-preceding group. Alternatively, the controller 19 obtains the number of commands in the group from which the command has been deleted, by counting the number of commands in the command-deleted group, and further obtains the number of commands in the one-preceding group, in the group registration information 153b.

The controller 19 obtains the sum of the number of commands in the command-deleted group and the number of commands in the one-preceding group. The controller 19 compares the sum with the threshold TH2, and judges whether the sum is equal to or less than the threshold TH2 (S13).

When the sum is not equal to or less than the threshold TH2 (No at S13), based on the group management information 153a and/or the group registration information 153b, the controller 19 obtains the sum of the number of commands in the command-deleted group and the number of commands in the one-following group (that is a group adjacent to the group in the group management information 153a and having a start LBA larger than that of the group). The controller 19 compares the sum with the threshold TH2, and judges whether the sum is equal to or less than the threshold TH2 (S14). When the sum is not equal to or less than the threshold TH2 (No at S14), the process proceeds to S18.

When the sum of the number of commands in the command-deleted group and the number of commands in the one-preceding group is equal to or less than the threshold TH2 (Yes at S13), the controller 19 renews the group management information 153a so as to integrate the command-deleted group with the one-preceding group (S15).

Alternatively, when the sum of the number of commands in the command-deleted group and the number of commands in the one-following group is equal to or less than the threshold TH2 (Yes at S14), the controller 19 renews the group management information 153a so as to integrate the command-deleted group with the one-following group (S16).

For example, an explanation will be given of a case where the threshold TH2=6, and a command CM2 is deleted from a group GR4 to which commands CM2, CM4, and CM5 belong, as illustrated in FIG. 6A. On the basis of the group management information 153a, the controller 19 obtains the current number of commands 3−1=2 in the group GR4. The controller 19 obtains the sum of the number of commands “2” in the group GR4 and the number of commands “5” in the one-preceding group GR3, i.e., obtains 2+5=7. The controller 19 compares the sum “7” with the threshold TH2 (=6), and judges that the sum is not equal to or less than the threshold TH2, and that integration of the group GR3 and the group GR4 is not suitable.

Then, on the basis of the group management information 153a, the controller 19 obtains the number of commands “4” in a group GR5 one-following the group GR4, and obtains the sum of the number of commands “2” in the group GR4 and the number of commands “4” in the one-following group GR5, i.e., obtains 2+4=6. The controller 19 compares the sum “6” with the threshold TH2 (=6), and judges that the sum is equal to or less than the threshold TH2, and that integration of the group GR4 and the group GR5 is suitable.

In accordance with this judgment result, the controller 19 renews the group management information 153a as illustrated in FIG. 6B, by integrating the current groups GR4 and GR5 into the group GR4.

For example, FIG. 7A illustrates the head LBAs of the respective commands that belong to the current groups GR3 to GR5. An explanation will be given of a case where, as illustrated in FIG. 7A, with respect to an address range of from the head LBA “700” of the current group GR4 to the tail LBA “1000” of the current group GR5, the command CM2 is deleted therefrom. In this case, as illustrated in FIG. 7B, the current groups GR4 and GR5 are integrated, and regrouped into a group GR4 of from a head LBA “700” to a tail LBA “1000”. Even where the current groups GR4 and GR5 are integrated into a group GR4, the number of commands in the group GR4 can be equal to or less than the threshold TH2 (=6).

With reference to FIG. 5 again, in accordance with the renewed group management information 153a, the controller 19 rearranges commands into groups (S18). Specifically, the controller 19 reconstitutes the group registration information 153b, and renews the group registration information 153b.

For example, in the case illustrated in FIGS. 6B and 7B, the group registration information 153b is reconstituted and renewed such that commands CM4, CM5, CM6, CM8, CM9, and CM16 belong to the group GR4.

The controller 19 selects each of the commands queued therein, and obtains a mechanical waiting time to be generated in a case where a selected command is executed following the command currently executed. By doing so, the controller 19 performs evaluation to determine an execution order of the commands that makes the mechanical waiting time minimum (S18). The controller 19 reorders (performs reordering to) the commands stored in the command queue 151 such that the commands come into the determined execution order (S19).

As described above, according to this embodiment, in the disk device 10, regrouping of a plurality of groups is dynamically performed so that the number of commands included each of them can fall within a predetermined range (such as a range equal to or less than the threshold TH1). Consequently, it is possible to achieve both of suppression of increase of the reordering process time and suppression of deterioration of the reordering process precision. Thus, it is possible to improve the command process performance at random access, even if command access is concentrated onto a specific address range.

It should be noted that the amount of data caused to access the volatile memory 15 by the controller 19 when the group division/integration is performed is larger than twice the amount of data caused to access the volatile memory 15 by the controller 19 when the group division/integration is not performed. For example, it is assumed that the group division/integration is not performed when a first command is enqueued into the command queue 151, and the group division is performed when a second command is enqueued into the command queue 151 or the group integration is performed when a third command is dequeued from the command queue 151. In this case, the controller 19 performs control such that data caused to access the volatile memory 15 is in a first data amount when the first command is enqueued into the command queue 151, and data caused to access the volatile memory 15 is in a second data amount larger than twice the first data amount when the second command is enqueued into the command queue 151 or when the third command is dequeued from the command queue 151.

Further, the group division/integration has been described as being performed when a command is received or completed, but the group division/integration may be performed at regular time intervals or during a background process.

Further, after the group division/integration is performed to a group including the head LBA of a command currently executed, if there is a sufficient spare time until the execution of the command currently executed is completed, the group division/integration may be further performed to another group.

Further, performing a process by using the grouping of commands may be applied not only to the reordering process but also to another process for the command queue 151. For example, the grouping of commands may be used for another process for the command queue 151, such as an overlapping check (to check whether the logical addresses of commands queued in the command queue 151 overlap with that of a command currently executed), or a cache bit check (to check whether data corresponding to the logical addresses of commands queued in the command queue 151 is stored in a cache memory (buffer 152)).

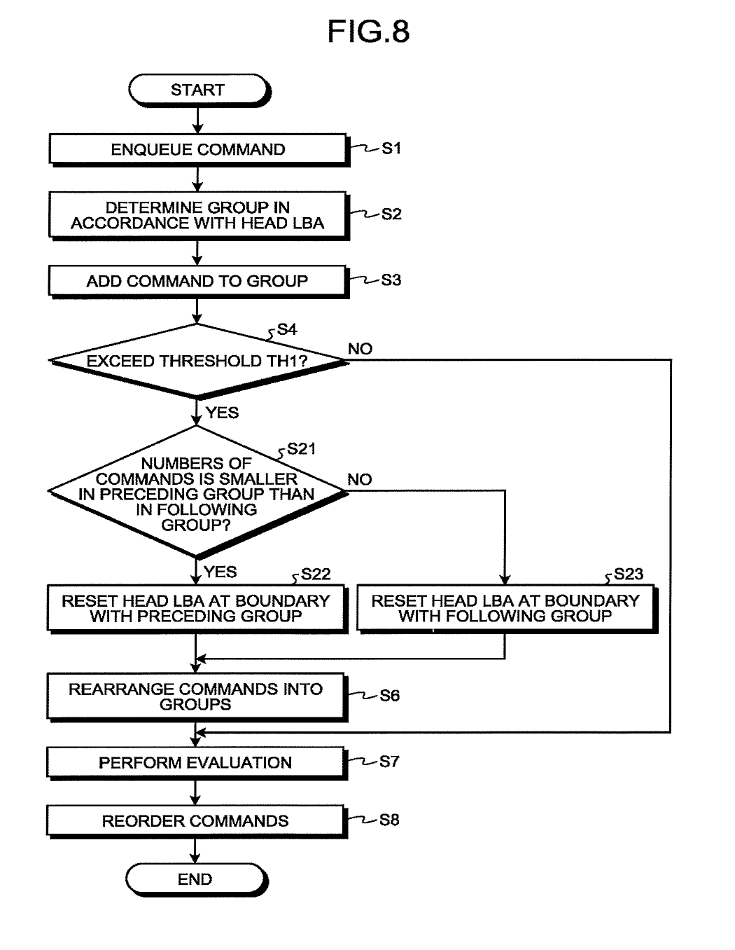

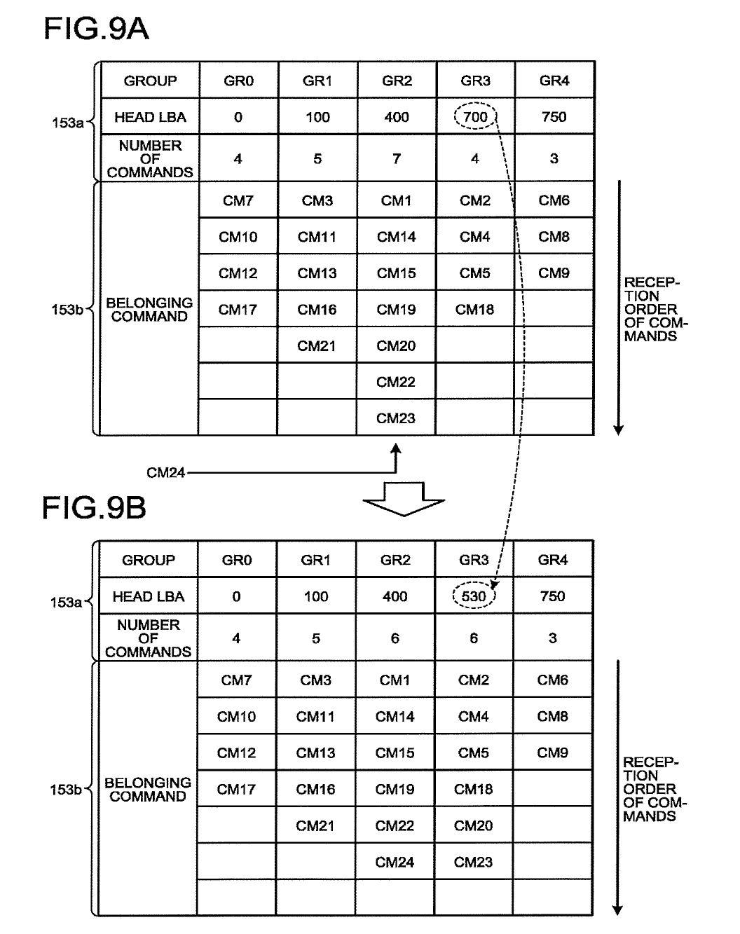

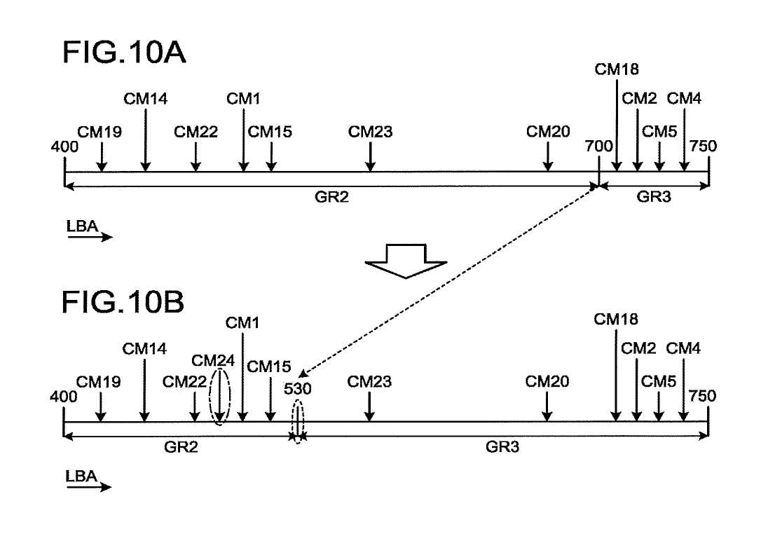

Further, in place of the group division, a process for shifting the boundary between groups may be performed. For example, in response to that a command is enqueued into the command queue 151, the controller 19 performs regrouping by shifting the boundary between groups, as illustrated in FIGS. 8 to 10B. FIG. 8 is a flowchart illustrating operations of the controller 19 in command enqueueing in a modification of the embodiment. FIGS. 9A, 9B, 10A, and 10B are diagrams illustrating operations of the controller 19 in the command enqueueing in the modification of the embodiment. In FIGS. 9A, 9B, 10A, and 10B, the reception order of commands from the host device HC is denoted by using CM+“number”.

After performing the processes of S1 to S3, the controller 19 compares the number of commands in the group to which the received command has been added, with the threshold TH1, and judges whether the number of commands in the received-command-added group exceeds the threshold TH1 (S4). When the number of commands in the received-command-added group exceeds the threshold TH1 (Yes at S4), the controller 19 compares with each other the numbers of commands in groups preceding and following this group (S21).

When the number of commands in the preceding group is smaller than the number of commands in the following group (Yes at S21), the controller 19 resets the head LBA indicating the boundary with the preceding group to be shifted into its own group side (S22).

When the number of commands in the preceding group is larger than the number of commands in the following group (No at S21), the controller 19 resets the head LBA indicating the boundary with the following group to be shifted into its own group side (S23).

For example, an explanation will be given of a case where the threshold TH1=7, and a command CM24 is added to a group GR2 to which commands CM1, CM14, CM15, CM19, CM20, CM22, and CM23 belong, as illustrated in FIG. 9A. On the basis of the group management information 153a, the controller 19 obtains the number of commands 7+1=8 in the group GR2. The controller 19 compares the number of commands “8” in the group GR2 with the threshold TH1 (=7), and judges that the number of commands in the group GR2 exceeds the threshold TH1. With reference to the group management information 153a, the controller 19 acquires the number of commands=5 in a group GR1 preceding the group GR2 and the number of commands=4 in a group GR3 following the group GR2. As there stands “the number of commands in the preceding group”>“the number of commands in the following group GR1”, the controller 19 determines to shift the boundary between the group GR2 and the group GR3 into the group GR2 side. In accordance with this judgment result, the controller 19 renews the group management information 153a as illustrated in FIG. 9B, by changing the head LBA of the group GR3 from 700 to 530. At this time, the controller 19 regroups the groups GR2 and GR3 such that the number of commands in each of the groups GR2 and GR3 falls within a predetermined range.

For example, FIG. 10A illustrates the head LBAs of the respective commands that belong to the groups GR2 and GR3. An explanation will be given of a case where, as illustrated in FIG. 10A, with respect to an address range of from the head LBA “400” of the group GR2 to the tail LBA “750” of the group GR3, the command CM24 is added to an address position illustrated in FIG. 10B. At this time, the boundary between the group GR2 and the group GR3 is shifted into the group GR2 side, as illustrated in FIG. 10B, such that the numbers of commands that belong to the respective groups GR2 and GR3 become almost equal to each other, after regrouping.

For example, in a case where the number of commands is expected to become larger in the group GR2 than in the group GR3 thereafter, the controller 19 may shift the boundary between the group GR2 and the group GR3 into the group GR2 side such that the numbers of commands in the group GR2 is made smaller than the numbers of commands in the group GR3. Alternatively, in a case where the number of commands is expected to become smaller in the group GR2 than in the group GR3 thereafter, the controller 19 may shift the boundary between the group GR2 and the group GR3 into the group GR3 side such that the numbers of commands in the group GR2 is made larger than the numbers of commands in the group GR3.

In accordance with the renewed group management information 153a, the controller 19 rearranges commands into groups (S6). Specifically, the controller 19 reconstitutes the group registration information 153b, and renews the group registration information 153b.

For example, as illustrated in FIGS. 9B and 10B, the group registration information 153b is reconstituted and renewed such that commands CM1, CM14, CM15, CM19, CM22, and CM24 belong to the group GR2, and commands CM2, CM4, CM5, CM18, CM20, and CM23 belong to the group GR3.

The controller 19 specifies a group to which the head LBA of a command currently executed belongs. The controller 19 selects each of the commands that belong to the group, and obtains a mechanical waiting time to be generated in a case where a selected command is executed following the command currently executed. By doing so, the controller 19 performs evaluation to determine an execution order of the commands that makes the mechanical waiting time minimum (S7). The controller 19 reorders (performs reordering to) the commands stored in the command queue 151 such that the commands come into the determined execution order (S8).

It should be noted that, if there is a sufficient spare time until the execution of the command currently executed is completed, the boundary shifting process (S21 to S23) may be further performed to the other group boundary not shifted, of the boundaries with the preceding and following groups. In addition, if there is a sufficient spare time, the boundary shifting process may be furthermore performed to a group other than the group including the head LBA of the command currently executed.

Also in this case, it is possible to achieve both of suppression of increase of the reordering process time and suppression of deterioration of the reordering process precision.

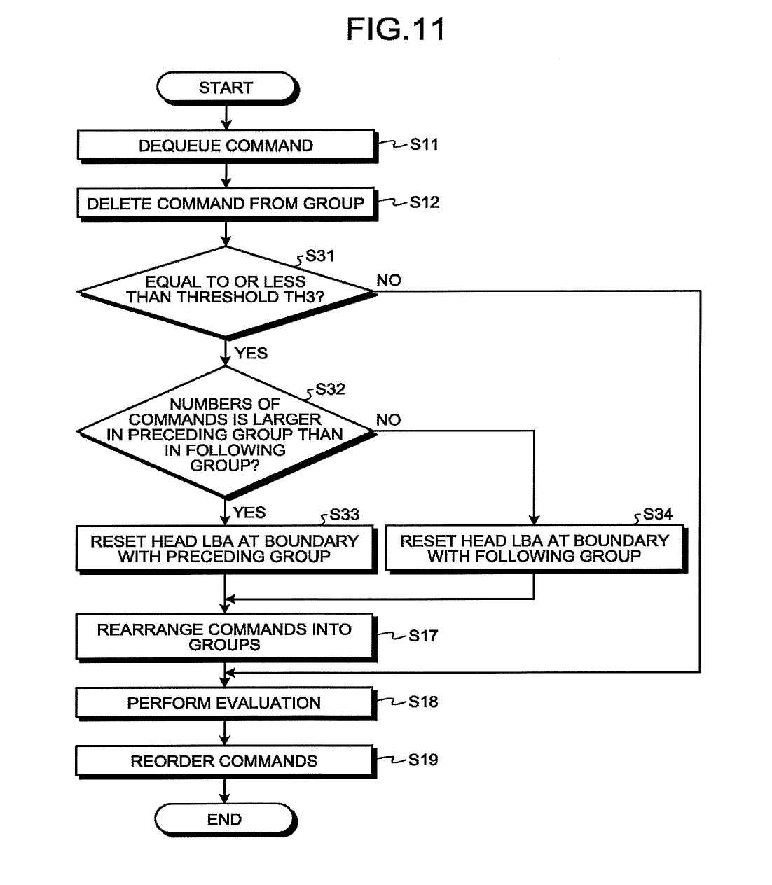

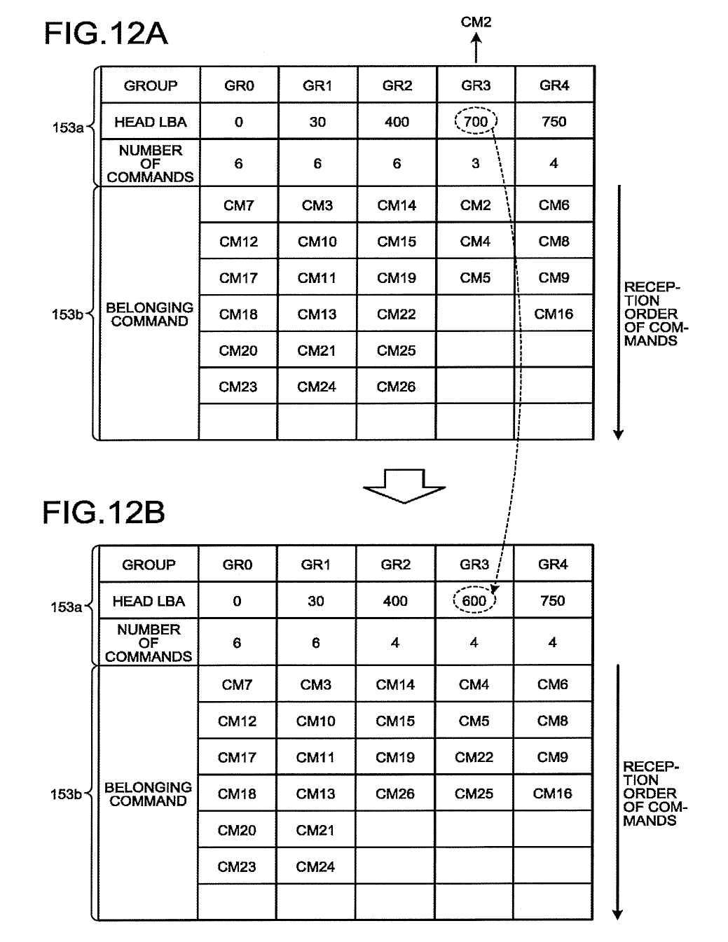

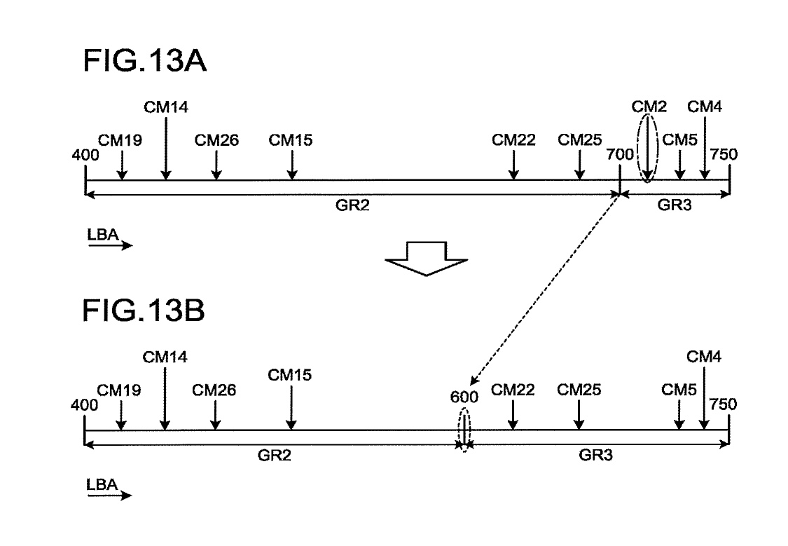

Alternatively, in place of the group integration, a process for shifting the boundary between groups may be performed. For example, in response to that a command is dequeued from the command queue 151, the controller 19 performs regrouping by shifting the boundary between groups, as illustrated in FIGS. 11 to 13B. FIG. 11 is a flowchart illustrating operations of the controller 19 in command dequeueing in another modification of the embodiment. FIGS. 12A, 12B, 13A, and 13B are diagrams illustrating operations of the controller 19 in the command dequeueing in the other modification of the embodiment. In FIGS. 12A, 12B, 13A, and 13B, the reception order of commands from the host device HC is denoted by using CM+“number”.

After performing the processes of S11 to S12, the controller 19 compares the number of commands in the group from which the command has been deleted, with a threshold TH3, and judges whether the number of commands in the command-deleted group has become equal to or less than the threshold TH3 (S31). The threshold TH3 is a threshold for judging whether there is a room to increase the number of commands that belong to a group, and has a value smaller than those of the threshold TH1 and the threshold TH2.

When the number of commands in the command-deleted group has not become equal to or less than the threshold TH3 (No at S31), the process proceeds to S17.

When the number of commands in the command-deleted group has become equal to or less than the threshold TH3 (Yes at S31), the controller 19 compares with each other the numbers of commands in groups preceding and following this group.

When the number of commands in the preceding group is larger than the number of commands in the following group (Yes at S32), the controller 19 resets the head LBA indicating the boundary with the preceding group to be shifted into the preceding group side (S33).

When the number of commands in the preceding group is not larger than (is smaller than) the number of commands in the following group (No at S32), the controller 19 resets the head LBA indicating the boundary with the following group to be shifted into the following group side (S34).

For example, an explanation will be given of a case where the threshold TH3=2, and a command CM2 is deleted from a group GR3 to which commands CM2, CM4, and CM5 belong, as illustrated in FIG. 12A. On the basis of the group management information 153a, the controller 19 obtains the number of commands 3−1=2 in the group GR3. The controller 19 compares the number of commands “2” in the group GR3 with the threshold TH3 (=2), and judges that the number of commands in the group GR3 has become equal to or less than the threshold TH3. With reference to the group management information 153a, the controller 19 acquires the number of commands=6 in a group GR2 preceding the group GR3 and the number of commands=4 in a group GR4 following the group GR2. As there stands “the number of commands in the preceding group GR2”>“the number of commands in the following group GR4”, the controller 19 determines to shift the boundary between the group GR2 and the group GR3 into the group GR2 side. In accordance with this judgment result, the controller 19 renews the group management information 153a as illustrated in FIG. 12B, by changing the head LBA of the group GR3 from 700 to 600. At this time, the controller 19 regroups the groups GR2 and GR3 such that the number of commands in each of the groups GR2 and GR3 falls within a predetermined range.

For example, FIG. 13A illustrates the head LBAs of the respective commands that belong to the groups GR2 and GR3. An explanation will be given of a case where, as illustrated in FIG. 13A, with respect to an address range of from the head LBA “400” of the group GR2 to the head LBA “750” of the group GR4, the command CM2 is deleted therefrom. At this time, the boundary between the group GR2 and the group GR3 is shifted into the group GR2 side, as illustrated in FIG. 13B, such that the numbers of commands that belong to the respective groups GR2 and GR3 become almost equal to each other, after regrouping.

Further, in a case where the number of commands is expected to become larger in the group GR2 than in the group GR3 thereafter, the controller 19 may shift the boundary between the group GR2 and the group GR3 into the group GR2 side such that the numbers of commands in the group GR2 is made smaller than the numbers of commands in the group GR3. Alternatively, in a case where the number of commands is expected to become smaller in the group GR2 than in the group GR3 thereafter, the controller 19 may shift the boundary between the group GR2 and the group GR3 into the group GR3 side such that the numbers of commands in the group GR2 is made larger than the numbers of commands in the group GR3.

In accordance with the renewed group management information 153a, the controller 19 rearranges commands into groups (S17). Specifically, the controller 19 reconstitutes the group registration information 153b, and renews the group registration information 153b.

For example, in the case illustrated in FIGS. 12B and 13B, the group registration information 153b is reconstituted and renewed such that commands CM14, CM15, CM19, and CM26 belong to the group GR2, and commands CM4, CM5, CM22, and CM25 belong to the group GR3.

The controller 19 specifies a group to which the head LBA of a command currently executed belongs. The controller 19 selects each of the commands that belong to the group, and obtains a mechanical waiting time to be generated in a case where a selected command is executed following the command currently executed. By doing so, the controller 19 performs evaluation to determine a command that makes the mechanical waiting time minimum (S18). The controller 19 reorders the commands stored in the command queue 151 such that the determined command is put at the head position of the command queue 151 (at a position for the command to be dequeued next) (S19).

It should be noted that, if there is a sufficient spare time until the execution of the command currently executed is completed, the boundary shifting process (S32 to S34) may be further performed to the other group boundary not shifted, of the boundaries with the preceding and following groups. In addition, if there is a sufficient spare time, the boundary shifting process may be furthermore performed to a group other than the group including the head LBA of the command currently executed.

Also in this case, it is possible to achieve both of suppression of increase of the reordering process time and suppression of deterioration of the reordering process precision.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a disk medium which stores data in accordance with addresses;
a command queue into which commands are enqueued in order; and
a controller which regroups a plurality of groups grouped correspondingly to the addresses in the disk medium in response to a command enqueued into the command queue or a command dequeued from the command queue, and which performs a process for the command queue based on the regrouped plurality of groups.

2. The disk device according to claim 1, wherein
the controller performs regrouping operation by dividing one or more groups among the plurality of groups in response to a command enqueued into the command queue.

3. The disk device according to claim 1, wherein
the controller performs regrouping operation by integrating two or more groups among the plurality of groups in response to a command dequeued from the command queue.

4. The disk device according to claim 1, wherein
the controller changes a boundary of the addresses between two groups adjacent to each other among the plurality of groups in response to a command enqueued into the command queue.

5. The disk device according to claim 1, wherein
the controller changes a boundary of the addresses between two groups adjacent to each other among the plurality of groups in response to a command dequeued from the command queue.

6. The disk device according to claim 1, wherein
the controller regroups the plurality of groups such that a number of commands in each of the plurality of groups falls within a predetermined range.

7. The disk device according to claim 2, wherein
the controller obtains a number of commands in a first group corresponding to the command enqueued, and performs regrouping operation by dividing the first group in response to that the number of commands in the first group exceeds a first threshold.

8. The disk device according to claim 3, wherein
the controller obtains a number of commands in a first group corresponding to the command dequeued and a number of commands in a second group adjacent to the first group, and performs regrouping operation by integrating the first group with the second group in response to that a sum of the number of commands in the first group and the number of commands in the second group becomes smaller than a threshold.

9. The disk device according to claim 7, wherein
the controller obtains a number of commands in a second group corresponding to the command dequeued and a number of commands in a third group adjacent to the second group, and performs regrouping operation by integrating the second group with the third group in response to that a sum of the number of commands in the second group and the number of commands in the third group becomes smaller than a second threshold, and
wherein the second threshold is smaller than the first threshold.

10. The disk device according to claim 4, wherein
the controller obtains a number of commands in a first group corresponding to the command enqueued, and changes a boundary between the first group and a fourth group adjacent to the first group by shifting the boundary into the first group side in response to that the number of commands in the first group exceeds a first threshold.

11. The disk device according to claim 5, wherein
the controller obtains a number of commands in a first group corresponding to the command dequeued, and changes a boundary between the first group and a second group adjacent to the first group by shifting the boundary into the second group side in response to that the number of commands in the first group becomes equal to or less than a threshold.

12. The disk device according to claim 10, wherein
the controller obtains a number of commands in a second group corresponding to a command dequeued from the command queue, and changes a boundary between the second group and a third group adjacent to the second group by shifting the boundary into the third group side in response to that the number of commands in the second group becomes equal to or less than a second threshold, and
wherein the second threshold is smaller than the first threshold.

13. The disk device according to claim 1, wherein
the controller reorders commands stored in the command queue based on registration information that correlates information to identify a command with information to identify a group allocated in accordance with the addresses, for respective one of commands queued in the command queue.

14. The disk device according to claim 1, wherein
the plurality of groups are grouped correspondingly to logical addresses, and
wherein the controller performs allocation to a command queued in the command queue with a group corresponding to a logical address included in the command queued among the plurality of groups.

15. A disk device comprising:
a disk medium;
a memory including a command queue; and
a controller that performs control such that data caused to access the memory is in a first data amount when a first command is enqueued into the command queue and data caused to access the memory is in a second data amount larger than twice the first data amount when a second command is enqueued into the command queue or when a third command is dequeued from the command queue.

16. A disk device control method comprising:
regrouping a plurality of groups grouped correspondingly to addresses in a disk medium, in response to a command enqueued into a command queue or a command dequeued from the command queue; and
performing a process for the command queue based on a regrouped plurality of groups.

17. The disk device control method according to claim 16, wherein
the regrouping includes performing regrouping by dividing one or more groups among the plurality of groups in response to a command enqueued into the command queue.

18. The disk device control method according to claim 16, wherein
the regrouping includes performing regrouping by integrating two or more groups among the plurality of groups in response to a command dequeued from the command queue.

19. The disk device control method according to claim 16, wherein
the regrouping includes changing a boundary of the addresses between two groups adjacent to each other among the plurality of groups in response to a command enqueued into the command queue.

20. The disk device control method according to claim 16, wherein
the regrouping includes changing a boundary of the addresses between two groups adjacent to each other among the plurality of groups in response to a command dequeued from the command queue.
